(19) United States
(12) Patent Application Publication
(10) Pub. No.: US 2015/0024356 A1
(43) Pub. Date: Jan. 22, 2015

(54) APPARATUS AND METHOD FOR INDUCING NEUROPLASTICITY

(71) Applicant: Juniper Multisensory Therapy ULC, Okotoks (CA)

(72) Inventors: Robert John Hillyer, American Fork, UT (US); Claudie Gordon-Pomares, Okotoks (CA)

(21) Appl. No.: 14/335,116

(22) Filed: Jul. 18, 2014

Related U.S. Application Data
(60) Provisional application No. 61/847,903, filed on Jul. 18, 2013.

(51) Int. Cl. G09B 5/00

(52) U.S. Cl. CPC G09B 5/00
USPC 434/236

(57) ABSTRACT

Apparatus and method for stimulating neuroplasticity. Neuroplasticity may be stimulated in functional brain tissue and used to improve or enhance function in adjacent, neuroanatomically-related, or otherwise associated dysfunctional brain tissue. The present apparatus and method may comprise a fully or partially automated system that can be programmed to detect and measure brain function in an individual, to select and provide the appropriate sensorimotor stimuli to target specific targeted brain function, to measure and detect changes in the targeted brain function, and to adapt the stimuli according to the changes in the targeted brain function.

### CROSS REFERENCE TO RELATED APPLICATION

This application claims priority to U.S. Provisional Patent Application No. 61/847,903, entitled “APPARATUS AND METHOD FOR THE MEASUREMENT AND TREATMENT OF NEUROLOGICAL DISORDERS,” and filed on Jul. 18, 2013, which is incorporated herein by reference in its entirety as if set forth in full.

### TECHNICAL FIELD

The present disclosure is generally related to an apparatus and method for stimulating or inducing neuroplasticity in relatively healthy brain tissue and driving the neuroplasticity to improve or enhance function in adjacent, anatomically-related, or otherwise associated dysfunctional brain tissue.

### BACKGROUND

The formation of new neural pathways and synapses in the brain occurs throughout life as a result of changes in an individual's behaviour, training, experience or environment via processes known as neuroplasticity or brain plasticity. Neuroplasticity is widely recognized as having an important role in healthy development, learning, memory and recovery from brain damage. As such, goal-directed methods of stimulating neuroplasticity have become the foundation of rehabilitation and treatment following brain injury.

Numerous methods for inducing neuroplasticity exist. Electrical stimulation of the brain to activate tissue is an established form of treatment. Abnormal or impaired functions of the cortex, the thalamus, and other brain regions have been treated effectively by delivering electrical energy to one or more target areas of the brain. These methods attempt to mimic normal neural activity, and may require the insertion and positioning of an electrical stimulation lead in a precise location in the brain proximate to the target area.

Non-invasive methods of inducing neuroplasticity are also known, including interactive cognition-enhancing computer programs. Cognitive training programs such as “Fast ForWord” aim to train or retrain the brain in individuals suffering from language and/or learning deficits. Such programs, however, are geared toward enhancing cognitive function and fail to specifically target dysfunctional or injured brain regions in isolation.

Environmental enrichment via sensorimotor stimulation can be used to increase neuroplasticity and induce brain reorganization. Sensorimotor stimulation ameliorates brain injury or genetically-based neurological disorders (e.g. Down's syndrome, Huntington's disease, Alzheimer's disease, schizophrenia, autism, etc.) via mechanisms such as altered neurotransmitter release and levels, cell growth and dendritic branching, altered synaptic density, and neurogenesis. However, known sensorimotor stimulation methods focus on improving overall brain function and are generally ineffective at treating localized brain dysfunction. Further, if sensorimotor treatment is administered improperly, it can cause stress in the patient, elevating brain temperature and exacerbating injury. Such treatments must also be tailored to each individual patient and must be closely monitored by the care giver administering treatment.

Known methods of inducing neuroplasticity are also unable to provide accurate or effective means for determining the specific brain region(s) that should be targeted for goal-directed treatment, and more particularly whether more than one brain region should be treated at a time. Clinicians are trained to diagnose brain disorders at the bed side by asking the individual questions about symptoms and having the individual perform cognitive tasks, but the diagnosis is dependent upon the clinician's training and the individual's ability to express their symptoms. Electroencephalography (EEG), positron emission tomography (PET), and functional magnetic resonance imaging (fMRI) can be used to accurately measure dysfunctional brain activity, but each of these methods requires complex and expensive medical equipment operated by trained medical professionals. These methods cannot readily be used to track an individual's response to treatment, nor can they be used to adapt the treatment (e.g. modify the treatment tools or regime used) according to the individual's response and changes in brain function.

There is a need for an apparatus and method capable of detecting and identifying dysfunctional brain tissue, determining the appropriate treatment to promote neuroplasticity and recovery in the targeted dysfunctional tissue, implementing the appropriate treatment, and adapting or modifying the treatment in response to changes detected in the targeted tissues. Such an apparatus and method may aim to target relatively healthy (non-dysfunctional) tissue to enhance or improve recovery in non-healthy (dysfunctional) brain tissue. Such an apparatus and method may utilize sensorimotor stimulation to induce mechanisms of neuroplasticity (e.g. neurotransmitter release, growth factor increases, neurogenesis, etc) in healthy brain tissue and to drive the mechanisms to induce neuroplasticity in at least one dysfunctional brain tissue.

### SUMMARY

Apparatus and method for non-invasively inducing neuroplasticity and neurogenesis to improve or enhance functional activity in the brain are provided. The present apparatus and method herein comprise a fully or partially automated system aiming to promote recovery in one or more brain regions by inducing neuroplasticity mechanisms in the tissue. Focused and balanced recovery can be promoted utilizing one or more sensory or motor stimuli, said stimuli being adaptable based upon the individual's response.

The present apparatus and method may serve to induce neuroplasticity in unhealthy or dysfunctional brain tissue by providing sensorimotor stimulation to healthy or functional brain tissue that is adjacent, neuroanatomically-linked, or otherwise associated with the dysfunctional tissue. The sensorimotor stimulation may comprise one or more sensory stimuli, motor stimuli or a combination thereof. The sensorimotor stimulation may be in the form of activities, exercises or sequences thereof. The sensorimotor stimulation may be selected to induce behavioural, neuroanatomical, or neurophysiological changes in the dysfunctional brain tissue.

More specifically, the present apparatus and method may be operative to:
a) identify one or more target brain tissues, said tissue being unhealthy or dysfunctional relative to healthy brain tissue,
b) identify one or more healthy brain tissues adjacent to, neuroanatomically-linked, or otherwise associated with the target brain tissue, and
c) select at least one sensorimotor stimulus for inducing mechanisms of neuroplasticity in the healthy tissue for promoting or enhancing the function of the target tissue.

Functional activity of the target tissue can be monitored over time such that one or more stimuli may be modified, adapted or customized in response to the feedback of the functional recovery. Recovery can be optimized by monitoring the readiness for growth of the tissue, by considering the relationships between brain regions, and benefiting from the capacity of one brain region to aide and drive repair in target brain tissues adjacent to, anatomically-linked, or otherwise associated therewith.

In one embodiment, a method is provided for inducing neuroplasticity in unhealthy brain tissue by providing sensorimotor stimulation to healthy brain tissue that is adjacent, neuroanatomically-linked, or otherwise associated with the unhealthy brain tissue.

In other embodiments, an apparatus is provided for inducing neuroplasticity in dysfunctional brain tissue comprising at least one processor operative to receive and analyze information about one or more dysfunctional brain tissues, to determine and select functional brain tissues adjacent to, neuroanatomically-linked, or otherwise associated with the dysfunctional brain tissues, to determine and select one or more sensorimotor stimuli for inducing neuroplasticity in the functional brain tissue to promote functional activity, neuroplasticity, neurogenesis or recovery in the dysfunctional brain tissue.

In yet other embodiments, the present apparatus and method may comprise a feedback component, enabling adaptability of the system to optimize results.

In yet other embodiments, the present apparatus and method may be fully or partially automated, eliminating the need for medical training.

In yet other embodiments, the present apparatus and method may be utilized to further stabilize the neural connections established by the neuroplasticity induced.

### DESCRIPTION OF THE DRAWINGS

FIG. 1 shows a flowchart exemplifying the present method;

FIGS. 2A-2D show various embodiments of implementing the automated embodiment of the present method;

FIG. 3 shows a flowchart exemplifying the measurement of brain functions' strength;

FIG. 4 shows an exemplified means for calculating the brain functions' strengths in response to user input and information from FIG. 3;

FIG. 5 shows an exemplified procedure for populating a list of factors;

FIG. 6 shows an exemplified procedure for populating a list of questions; and

FIG. 7 shows an exemplified procedure for populating a list of brain functions.

### DESCRIPTION OF THE EMBODIMENTS

Apparatus and methods are described for inducing mechanisms of brain plasticity or neuroplasticity in healthy (non-dysfunctional) brain tissue and driving said mechanisms to promote recovery in non-healthy or dysfunctional brain tissue. Non-healthy brain tissue may be adjacent, neuroanatomically-linked or otherwise associated with the healthy tissue. Using embodiments herein, apparatus and methods may comprise detecting and identifying localized “target” dysfunctional brain tissue for treatment, determining the appropriate sensorimotor stimulus (or “tools”) to promote recovery by inducing neuroplasticity in the target tissue, implementing the stimulus tools, measuring functional changes in the target tissue and adapting the tools in response to feedback from the target tissue.

Herein, unless the context sets forth otherwise, the following terms are used for the purposes of describing an example of the present apparatus and method only and are not intended to narrow or limit the scope in any way:

“Healthy (non-dysfunctional) brain tissue/region” means unimpaired, relatively normal functioning brain tissue or brain regions having at least substantially superior brain function compared to unhealthy brain tissue; and

“Unhealthy (dysfunctional) brain tissue/region” means impaired, relatively abnormal or dysfunctional brain tissue or brain regions having at least substantially inferior brain function compared to healthy brain tissue. Unhealthy brain tissue may or may not be injured tissue. Apparatus and methods herein aim to:

a) identify one or more unhealthy brain tissues or regions,

b) identify one or more healthy brain tissues or regions adjacent to, neuroanatomically-linked, or otherwise associated with the unhealthy tissue, and

c) determining and selecting at least one sensorimotor stimuli for inducing mechanisms of neuroplasticity in the healthy tissue to promote recovery in the unhealthy tissue.

Without limitation, apparatus and methods herein may serve to drive mechanisms of neuroplasticity induced in healthy tissue to unhealthy tissue linked therewith and to promote recovery thereof. For example, it was determined that a relatively healthy region of the motor cortex (e.g. the hand) may be utilized to induce neuroplasticity in at least one unhealthy region of the motor cortex (e.g. the mouth or musculature relating to speech). A skilled person would know and understand that the “hand”, “mouth” or “speech” regions are used to as an exemplary representation of any healthy brain tissue that is adjacent, anatomically-associated, or otherwise linked to one another. Terms such as “mouth” or “speech” are used in a broad sense and are not intended to limit the scope of the invention. For example, terms such as “language areas” could also be used.

The present apparatus and method may comprise a fully or partially automated system operative to detect and measure brain function of an individual, to determine and implement the appropriate sensorimotor stimuli for target the brain function, to measure and detect changes in the brain function in response to the stimuli, and to adapt the stimuli according to the changes in brain function. The present system may be customizable, and may serve individuals whose input to the system may be incomplete or deficient. The present system may provide a means for treating more than one brain region simultaneously and without the need for a specific diagnosis.

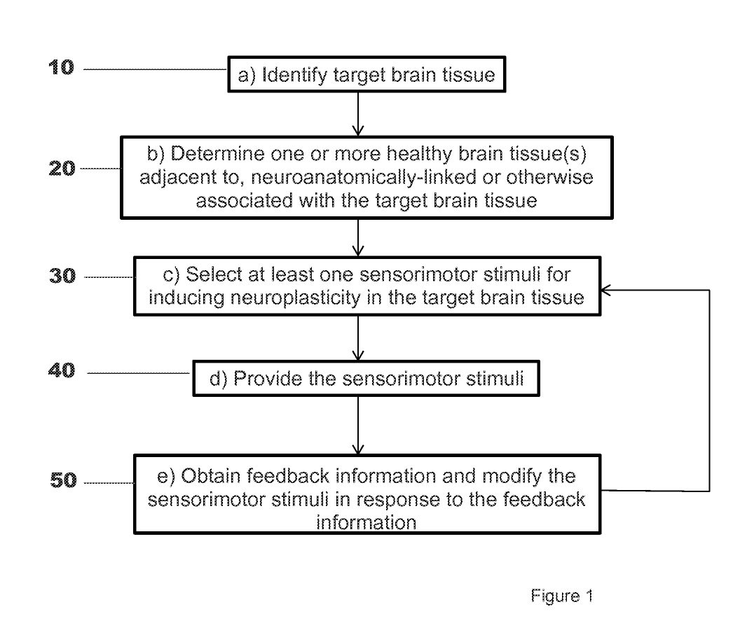

In embodiments herein, unhealthy brain tissue can be identified by measuring an individual's abilities in order to determine behavioural dysfunction, or by determining behavioural goals or desired outcomes of an individual. Having regard to FIG. 1, the present apparatus and method comprises a system generally capable of:

a) Identifying 10 one or more target brain tissue(s) by:
providing questions to an individual, said questions capable of providing information about the individual's brain function,
receiving the answers to the questions in the form of input information, wherein the input information may reflect the function (e.g. behavioural function) of at least one brain region or the desired goals of the individual,
analyzing the input information to determine any dysfunction in the at least one brain region or the desired goals of the individual,

b) Determining 20 one or more healthy brain tissue(s) adjacent to, neuroanatomically-linked or otherwise associated with the target brain tissue (such healthy tissues referred to as the “Brain Tools”),

c) Based upon the Brain Tools determined, selecting 30 at least one sensorimotor stimulus for inducing neuroplasticity in the target brain tissue by:
analyzing the input information and the selected Brain Tool(s) to determine one or more appropriate sensorimotor stimuli for targeting the dysfunctional brain tissue, said sensorimotor stimuli being selected to induce neuroplasticity mechanisms in the Brain Tools adjacent to, anatomically-linked or otherwise associated with, the at least one dysfunctional brain region,

d) Providing 40 the one or more selected sensorimotor stimuli to the individual, the stimuli being in the form of activities, exercises or exercise sequences, and

e) Modifying 50 or adapting the sensorimotor stimuli based upon the response of the individual by,
providing further questions to the individual, said questions being capable of providing information about the individual's brain function,
receiving the answers to the questions in the form feedback information, wherein the feedback information may reflect the function (e.g. behavioural function) of at least the targeted brain tissue or the desired goals of the individual,
analyzing the feedback information to determine any change in function in the targeted brain tissue or the desired goals of the individual,
based upon the detected change in brain function, modifying or adapting the sensorimotor stimuli provided to the individual.

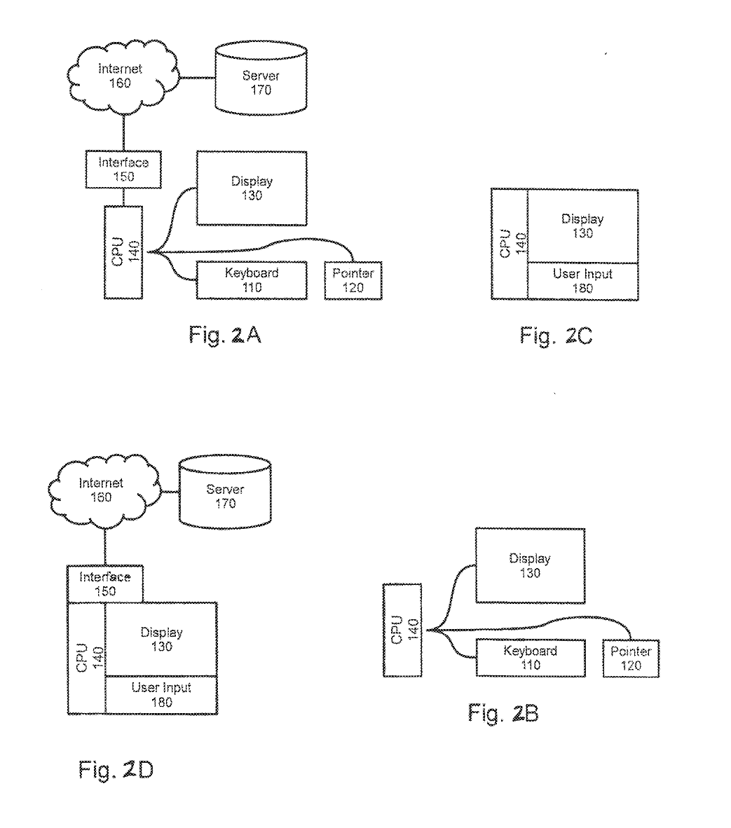

Without limiting the foregoing, the present apparatus and method will now be described in more detail. Having regard to FIG. 2, according to embodiments herein, the present apparatus and method may be implemented via a processor or computing device (CPU) 140, said CPU having internal or external data storage capabilities (FIGS. 2A, 2B). CPU 140 may provide access to the individual user, via a user interface 150, to the internet 160. The user may be prompted to provide information on a display 130 on a stationary point-of-care device, via a keyboard 110 and/or pointing device 120, or any other appropriate means for obtaining user information 180 directly or indirectly can be used such as a mobile device (e.g. touch screen) with or without internet access (FIGS. 2C, 2D). It is understood that the term “user” herein may refer to the individual receiving or benefiting from the treatment, or a caregiver or medical professional entering the information on the individual's behalf.

Target brain tissue may first be identified by prompting the individual user to answer one or more questions 200, the questions 200 being designed such that the answers can be used to obtain and measure information about the individual's brain function and desired goals. Questions 200 may be configured to obtain input information 180 in a manner that can be collected 220, analyzed (measured and scored) and stored 230 by computing device 140. Computing device 140 may be configured to cross-reference input information 180 and to transform the information into numerical values, such that changes to the values can be determined over time.

Some questions 200 may not be associated with a particular brain function or goal 250, but may provide input information 180 on the degree of stress or environmental factors affecting the user. Some questions 200 may be configured to determine the user's skill level, whether an exercise or activity can be achieved, or directed to determining the user's goals, without being associated with brain function. Some question 200 may be designed according to the particular brain function being targeted, or based upon the activity or readiness for growth of the targeted tissue. Questions 200 may be designed to identify localized target tissue or specific brain function 250 including, for example, one or more of the following: neurotransmitter-related dysfunction (e.g. serotonin, dopamine), motor or sensory-related dysfunction (e.g. olfactory, vision, eye scanning, facial recognition, auditory, gross and/or fine motor, tactile response, vestibular, proprioception), memory, mental imagery, corpus callosum, defense responses, vagal or digestion dysfunction, or any combination thereof.

Questions 200 may be used to determine brain function 250 strength may be asked in a way that gives the user an opportunity to report minor improvements within the question 200, and offer fractional or decimal increase in the score of said question. Improvements observed give developmental cues that a brain function may be ready for developmental focus. The present apparatus and method, or improvements detected as a result, may be used generally as a tool to measure brain function or to measure or diagnose neurological disorders.

Questions 200 may be simple and about general aspects of life, or selected to more effectively map localized brain functions; provided that they lend themselves to being scored numerically on a rating scale. The type of rating scale may differ from a simple rating of 0 or 1, a more complex rating of 0 to 10 or 100, or an arbitration measurement such as a percentage.

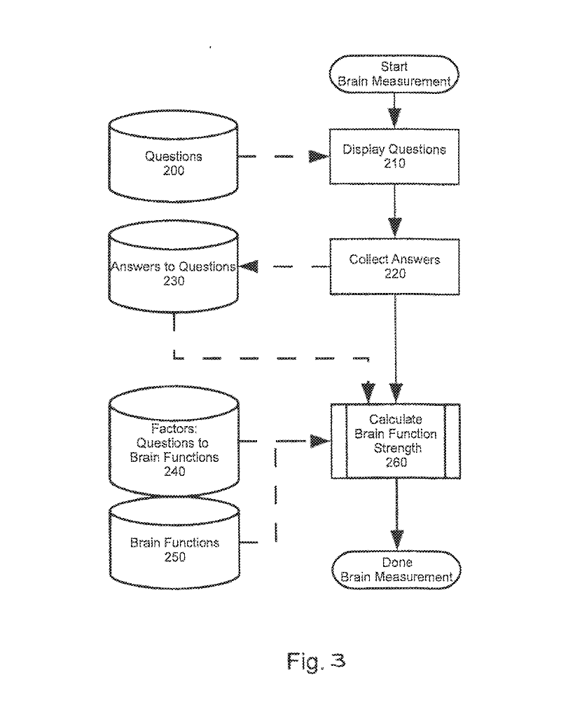

By way of example and having regard to FIG. 3, questions 200 relating to an area of life for the user may be displayed 210 for the user to read and answer. Questions 200 may ask the user to rate the questions according to whether that area of their life is:
a) “not a problem”, resulting in a rating of 5,
b) “may be a problem”, resulting a rating of a 4,
c) “a little bit of a problem”, resulting in a rating of 3,
d) “a big problem”, resulting in a rating of 2,
e) “a severe problem”, resulting in a rating of 1,
f) “couldn't be worse”, resulting in a rating of 0, or
g) “not applicable”, resulting in no rating for that question.

While the type of rating scale can vary, it is desired that the user be able to provide an answer where a question 200 is “not applicable”, in which case the question 200 may be ignored. Although questions 200 can have designated values, one primary purpose of questions 200 is to identify target brain tissue, and to measure functional changes in targeted brain tissue. For example, questions may be scored on how well it represents the function or goal, and how much improvement was observed in the function or goal over time.

Once questions 200 are configured, a list of brain functions 250 can be used to determine a list of factors 240, the factors 240 representing numerical values that relate each question 200 to each brain function 250. There may be one factor 240 for each combination of question 200 and function 250. Using the numerical values of the answers to the questions 200, the list of factors 240 and the list of brain functions 250, a calculation can be done for each brain function 250, wherein the calculation may provide a value of brain function strength for each brain function. It is contemplated that one or more target unhealthy tissues 250 may be identified and treated alone or simultaneously in combination.

For example, each question 200 can be connected to the target tissue or goal by representing the tissue or goal with a chosen factor 240, where the factor ratio (factor/5) can be used (a “connection score”). Factors 240 can be used to analyze changes in activity in the target tissue (e.g. functional improvements) over time in one of the following ways. First, an “improvement score,” being a simple measure of how much improvement actually occurred divided by the most improvement that could have occurred (improvement/5), could be determined. Second, an improvement score could instead weigh only the improvement that occurred on applicable questions. For example, once a particular goal is identified, questions unrelated to that goal that provide input showing improvement may be disregarded as being a distraction. In such a case, the (improvement/5) may be multiplied by the (factor/5).

Final question scores can be weighted to determine how much the final score is made up of the connection score and tempered by the improvement score. For example, Question(j)=Question(connection)×(w)+Question(improvement)×(1−w), where:

Question(straight)=factor/5

Question(pass)=1

Question(pre-tempered)=Question(straight)×(RW relationship weight)+Question(pass)×(1−RW)

Question(tempered)=Question(pre-tempered)×Improvement/5

Question=Question(pre-tempered)×(TW tempered weight)+Question(tempered)×(1−TW).

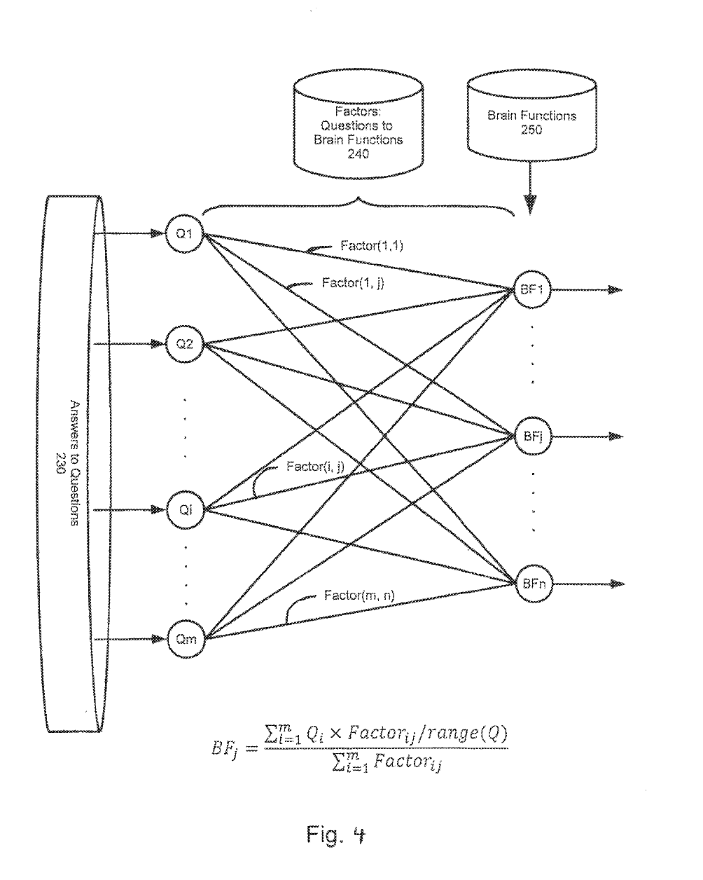

FIG. 4 depicts an exemplary flowchart of the calculations of the present apparatus and method, wherein the answers 230 are collected, analyzed and used to determine the corresponding strength of brain function 250, using the following equation:

$${BF}_{j} = \frac{{\sum }_{i = 1}^{m} {Q}_{i} \times {Factor}_{ij} / range ( Q )}{{\sum }_{i = 1}^{m} {Factor}_{ij}}$$

wherein “Q1, Q2, . . . Qi” represent answered questions,
‘m’ represents answered or not ignored questions,
‘n’ represents the number of brain functions listed,
‘i’ represents an index representing the question in the sequence (or the ‘i'th’ question),
‘j’ represents an index representing brain function in the sequence (or the ‘j'th’ brain function),
BFj is the “j'th” brain function,
Qi is the “i'th” question, and
Range (Q) is the value that a maximum score on a question could be.
Factor (i,j) is the factor relating the “i'th” question with the “j'th” brain function. The factors are indexed to reference a relationship between each question and each brain function such as, for example, factor (i,j) is the factor that relates the ‘i'th’ question to the ‘j'th’ brain function. There is a factor for each combination of ‘i’ and T, where ‘i’ is sequenced from 1 to ‘m’ and T is sequenced from 1 to ‘n’. Factor (1,1) relates question 1 with brain function 1. Factor (1,2) relates question 1 with brain function 2, and so on. Factor (2,1) relates question 2 with brain function 1. Factor (2,2) relates question 2 with brain function 2, and so on. The value of the factor (i,j) on a scale of 0 to 5 represents the degree that the strength in question i indicates the strength in brain function j.

Dividing by this factor normalizes the score of answers to the questions to a numerical value between 0 and 1. Using the present example scoring system, the maximum score that could be assigned is a 5 representing that the aspect of life is “not a problem,” making range (Q) equal to 5.

Dividing by the sum of the factors instead of the count of the factors can address circumstances where very few questions are related to a brain function (i.e. most questions are not related to the brain function). Having few questions related to a brain function will make the sum of the multiplication very low, and in effect a brain function will be penalized by not having many questions to measure it. By dividing by the sum of the factors instead of the count of the factors, then brain functions with lower count of related questions, or a high count of very weakly related questions can score evenly with brain functions with high counts of related questions and strongly related questions.

It is contemplated that measure of brain function 250 may be overridden to increase certain brain function(s) score based on the goal of the individual. For example, if the goal of the individual is an increase in fine motor, then the fine motor brain function measure may be increased to give it more focus.

Factors 240 may be changed and new questions 200 or functions 250 may be added to the as desired or required. Changes or additions to the factors, questions, functions (or exercises) may be adjusted based upon feedback from the present system using a learning system or other automation.

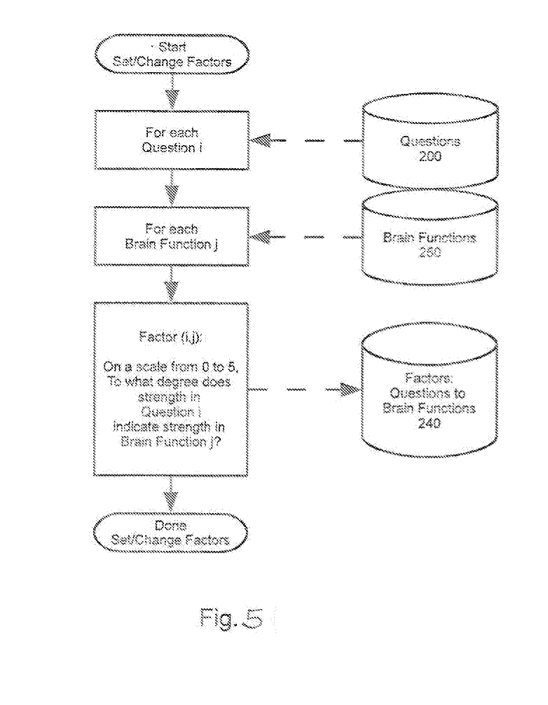

Once brain functions 250 have been defined, and questions 200 have been formulated, the list of factors 240 can be populated. The list of factors 240 may be populated as provided in FIGS. 5, 6 and 7. Where a count of ‘m’ questions and a count of ‘n’ brain functions is determined, there will be m×n factors to populate.

Having regard to FIG. 5, ‘i’ can be used in conjunction with the questions as an index to represent the concept of each question in sequence, or the “i'th” question. ‘j’ is used in conjunction with the brain functions 250 as an index to represent the concept of each brain function in sequence, or the “j'th” brain function. For each question “i” in the list of questions, each brain function ‘j’, factor (i,j) can be determined. The numerical response between 0 and 5 is stored in the list of factors. The numerical response can be an integer, or it can be a decimal value. This procedure can be followed when setting up the list of factors 240 and when changing factors in the list of factors.

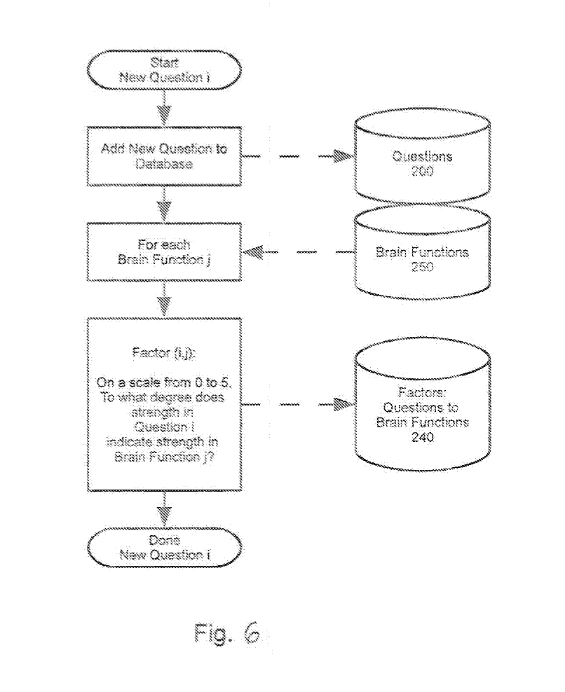

Questions can be added using the procedure outlined in FIG. 6. For example, if a new question ‘i’ is added, it can first be added to the list of questions 200. Given that new question ‘i’, for each brain function ‘j’ in the list of brain functions 250, factor (i,j) can be determined. The numerical response between 0 and 5 can be stored in the list of factors 240, said response being an integer or a decimal value.

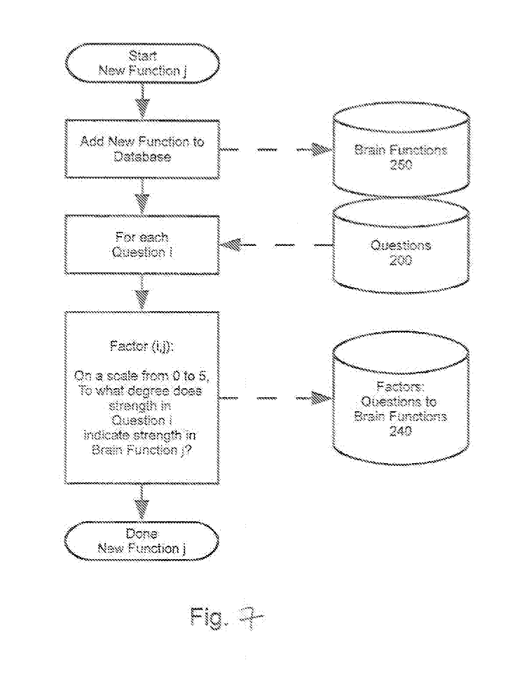

Brain functions 250 can be added using the procedure outlined in FIG. 7. For example, where a new brain function ‘j’ is added, it can first be added to the list of brain functions 250. Given that new brain function ‘j’, for each question ‘i’ in the list of questions 200, factor ‘i,j’ can be determined. The numerical response between 0 and 5 can be stored in the list of factors 240, said response being an integer or a decimal value.

Once the questions 200 have been connected to the appropriate brain function(s) 250 identified, one or more healthy brain tissues or regions that are adjacent to, neuroanatomically-linked or otherwise connected to the target tissue can be identified. It is contemplated that the healthy tissue can be used to drive neuroplasticity in the target tissues and, as such, can be referred to as a “Brain Tool” (not shown). Brain Tools may be selected based upon their ability to stimulate neuroplasticity, connect to unhealthy tissue, or the level or degree of function of the Brain Tool. For example, the higher functioning the Brain Tool and the stronger the connection of the Brain Tool to the unhealthy tissue, the more likely it is that the Brain Tool may be selected. Alternatively, where a Brain Tool is strongly linked to non-target brain function, the Brain Tool should may not generally be used. It is desired that there be a balance between the strength of the linkage to the target tissue and the Brain Tool activity, which can be determined by a temperance weight w(sub)T, as follows:

$${BT}_{jCONNECTSTRAIGHT} = \frac{{\sum }_{i = 1}^{m} {BF}_{i} f ( i , j )}{m}$$

$${BT}_{jCONNECTPASS} = \frac{{\sum }_{i = 1}^{m} {BF}_{i}}{m}$$

$${BT}_{jCONNECT} = {BT}_{jCONNECTSTRAIGHT} ( {w}_{R} ) + {BT}_{jCONNECTPASS} ( 1 - {w}_{R} )$$

$${BT}_{jACTIVE} = \frac{{\sum }_{i = 1}^{m} {S}_{i} f ( i , j )}{{\sum }_{i = 1}^{m} f ( i , j )}$$

$${BT}_{jTEMPERED} = {BT}_{jCONNECT} {xBT}_{jACTIVE} ( if completely tempered , before temperance weight )$$

$${BT}_{j} = {BT}_{jTEMPERED} ( {w}_{T} ) + {BT}_{jCONNECT} ( 1 - {w}_{T} )$$

The factor f(i,j) in the above formulae being determined as a factor relating how adjacent, anatomically-related, or otherwise associated the “i'th” brain function 250 is to the “j'th” Brain Tool. W(sub)R and W(sub)T are adjustable weights used to adjust the result to give more or less weight to the corresponding principle within the calculation. To give more weight to the relationship between brain function 250 and the Brain Tool, W(sub)R is set closer to 1. To give more weight to the strength of the Brain Tool, W(sub)T is set closer to 1. Both weights can be set at the same or different values between 1 and 0.

Because of the case where some relationships may be stronger than others, there needs to be a weighting of the strength of that relationship. The weights can be adjustable, and utilized as a resource for the feedback or learning capabilities of the present system and method. Where inappropriate sensorimotor stimuli are selected, the calculations can be analyzed to determine why. If the result shows an exaggeration of a relationship, the weight for that relationship can be reduced. If the result shows that a relationship is not given enough consideration, then the weight for that relationship can be increased.

Once one or more Brain Tools are selected, the Brain Tool(s) can be used to guide the type of sensorimotor stimulation used to induce neuroplasticity, said sensorimotor stimulation being selected to provide behavioural, neuroanatomical, and/or neurophysiological improvement. In one embodiment, the present apparatus and method may utilize sensorimotor stimulating activities, exercises or exercise sequences for encouraging neural plasticity and neurogenesis. For example, the sensorimotor stimuli may be in the form of automatic or manual exercise sequences performed actively or passively by the individual or by a caregiver performing the exercise on the individual. Some activities, exercises and exercises sequences may target specific Brain Tools, while others may target a broader range of tissues or functions. Some activities, exercises and exercise sequences may be more difficult, more exhausting or draining, or more well-rounded than others.

Selection and implementation of the activities, exercises and exercise sequences may be automated, in whole or in part. The weighting used to rate the desirability of the selecting an activity, exercise or exercise sequence can be determined as follows:

$${Exercise}_{jSTRAIGHT} = \frac{{\sum }_{i = 1}^{m} {BT}_{i} f ( i , j )}{{\sum }_{i = 1}^{m} f ( i , j )}$$

$${Exercise}_{jPASS} = \frac{{\sum }_{i = 1}^{m} {BT}_{i}}{m}$$

$${Exercise}_{j} = {Exercise}_{jSTRAIGHT} ( {w}_{R} ) + {Exercise}_{jPASS} ( 1 - {w}_{R} )$$

The list of available activities, exercises, and/or sequences may be sorted in order of the highest weighting to lowest in order to sort by most desired to least desired activity, exercise, or sequence. If an activity, exercise or exercise sequence is not reasonable (e.g. achievable) for the individual it may be given a negative value prior to sorting so that it is transferred to the bottom of the list following sorting. In addition, some activities, exercises or exercise sequences should not be considered, for example where it has been utilized too many consecutive times (it is desirable that the exercises be balanced). Each activity, exercise or exercise sequence may therefore be given a “drop” rate and a “reinstatement” rate. If the activity, exercise or exercise sequence has been assigned consecutively more times than the drop rate it can be removed until a certain number of session pass, which exceed its reinstatement rate.

An activity, exercise or exercise sequence should also not be considered if it is too easy or too hard or if the individual is unable to perform the activity or it is painful. It is contemplated that other situations may arise where an activity, exercise or exercise sequence should not be included and a special set of rules can be devised in such circumstances. Some activities, exercise or exercise sequence may have prerequisite activities, exercises or exercise sequences, which should be performed prior to initiating the present intervention.

Each activity, exercise or exercise sequence may further be given a “drain” factor, which means that a sequence of exercises will have the drain of all of the exercises within it combined. The degree of drain may be considered when choosing activities, particularly when considering there is a high dilution factor for a sequence. This dilution factor refers to how many Brain Tools are attached to the sequence. The strength of the brain function, the sum of the drain and the dilution all affect the sequence of exercises in an independent manner. Given a numerical value for drain, and dilution factor for each activity, exercise, or exercise sequence, it may be used to set a limit on the number or selection of activities, exercises, or exercise sequences offered to the individual to complete.

In operation, the selected stimuli of the present apparatus and method may be provided to an individual at least once per day. The selection of new stimuli may occur where a response to the stimuli is observed (for e.g. where improvement is observed), or on a predetermined time-based interval (for e.g. every two weeks). For selecting new stimuli, the individual is prompted to answer questions 200, which are collected, analyzed and stored in the form of information 180 that can be processed to identify target brain tissue, to determine one or more healthy brain tissues(s) adjacent to, neuroanatomically-linked or otherwise associated with the target brain tissue (a “Brain Tool”), to select at least one sensorimotor stimuli capable of at least inducing neuroplasticity in the target brain tissue, perhaps via mechanisms of stimulating neuroplasticity in the Brain Tool and driving said mechanisms to the target tissue.

In embodiments herein, the information 180 can further be utilized for comparative purposes over time (e.g., on a regular basis). Comparisons can be used to detect and measure changes in neural activity and growth, and hence the readiness of different brain tissues to achieve functional recovery. Where neuroplasticity (e.g. enhanced activity) is detected in target tissue, the present system and method may adapt in response, optimizing results. Alternatively, where negative results are observed (e.g. no activity, or detrimental effects), the present system and method may adapt in response.

The present apparatus and method may be utilized to stabilize connections between the Brain Tool and the target tissue(s), and driving neuroplasticity between the regions. One or more activity, exercise, or exercise sequence may be combined together to form a custom treatment regime, or “worksheet.” Worksheets can be developed to, for example, limit the selection of exercises by number, drain, or similarity to other activities, exercises or exercise sequences already assigned on the present or past worksheets.

In embodiments herein and without limitation, sensorimotor activities and exercises of the present apparatus and method may be utilized to target or promote one or more of the target brain tissues. For example, sensorimotor stimuli relating to smell, touch (for example, thermal input, texture input, gentle touch), taste, sight (for example, pleasant visual stimulus, eye scanning, blindfolding), auditory, balance, and motion (for example, walking, modified or challenged walking, kicking, reaching, fine motor, clasping, stretching, dropping) may be used. It is contemplated that more than one sensorimotor stimuli may be used at one time. For example, where stimulation of the olfactory cortex (e.g. smell) alone will not produce the desired result, the olfactory stimuli may be combined with other sensory stimuli (e.g., light).

The present apparatus and method may be capable of automatically determining and optimizing the sensorimotor activities and exercises to promote recovery. For example, it is desired that the activities and exercises be gentle, focused, reach a therapeutic threshold, are within the physical capabilities of the individual (not too hard or too easy) and adaptable to the individual's responsiveness to treatment. It is further desired that the activities and exercises balance novelty with repetition, while minimizing pain. Where an individual is succeeding in the performance of repetitive sensorimotor stimuli, the activities or exercises can be continued until such time as no further improvement is measured, at which time different or more difficult stimuli can be provided. It is understood that all or some of the sensorimotor stimuli may be suspended or ceased where it is determined to be stressful, draining, overly broad or overly specific. The present apparatus and methods may be tailored to the strengths and weakness of particular individuals. For example, where the user of the present apparatus and method is autistic, loud or bright sensorimotor stimuli can be avoided. Further, a stimulus may have a prerequisite stimulus which must be completed before the desired stimulus is used.

Sensorimotor stimuli may be selected to optimize recovery in the target brain tissue. Without limitation, it is desired that the sensorimotor stimuli may serve to first “activate” the target tissue to get it ready for treatment (e.g., to notice or learn something). Second, the stimuli exercise may serve to promote recovery or “fix” the target tissue by encouraging neural growth and connections of the activated tissue. Finally, the stimuli may serve to reinforce and maintain (i.e. “stabilize”) the growth or connections that are formed between the target tissue and the healthy tissue adjacent, neuroanatomically-linked, or otherwise associated therewith. It is understood that the present system and method may be capable of providing one or more of the foregoing alone or in combination. Indeed, sensorimotor stimuli that can activate, fix and stabilize may be selected as an appropriate “sequence.” Once selected, the appropriate sequence can be performed by the individual, preferably at least once or twice a day. Neuroplasticity may be induced with minimal activity each day, with much of the recovery occurring after the activity ceases and the tissue is at rest. As such, it may be desirable to limit the number of sequences.

The present method may be used to treat one or more brain dysfunctions in an individual, and may further be adapted and optimized as the brain responds. For example, where improvement is detected and measured in one dysfunctional brain region, the present apparatus and method may be modified and geared towards the responsive dysfunctional brain tissue to further improve recovery (a weak area which begins to show strengthening can be targeted more directly). It is contemplated that the present apparatus and method may be used alone or in combination with other mechanisms for stimulating brain recovery.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A method for inducing neuroplasticity in dysfunctional brain tissue by providing sensorimotor stimulation to functional brain tissue that is adjacent, neuroanatomically-linked, or otherwise associated with the dysfunctional brain tissue.

2. The method of claim 1, wherein the sensorimotor stimulation comprises one or more sensory stimuli, motor stimuli or a combination thereof.

3. The method of claim 1, wherein the sensorimotor stimulation may be in the form of activities, exercises or sequences thereof.

4. The method of claim 1, wherein the sensorimotor stimulation may be selected to induce behavioural, neuroanatomical, or neurophysiological changes in the dysfunctional brain tissue.

5. A method for inducing neuroplasticity in at least one brain tissue, the method comprising:
identifying and selecting one or more dysfunctional brain tissues,
identifying and selecting one or more functional brain tissues adjacent to, neuroanatomically-linked or otherwise associated with the dysfunctional tissue, and
identifying and selecting at least one sensorimotor stimuli for targeting the dysfunctional brain tissue by inducing mechanisms of neuroplasticity in the functional brain tissue adjacent to, neuroanatomically-linked or otherwise associated with the dysfunctional tissue.

6. The method of claim 5, wherein the dysfunctional brain tissues are identified by at least the following steps:
providing questions configured to obtain information about the at least one dysfunctional brain tissues, and
analyzing the information to determine any dysfunction in the at least one brain tissues.

7. The method of claim 5, wherein the functional brain tissues are identified by at least the following steps:
providing questions configured to obtain information about the at least one dysfunctional and functional brain tissues,
analyzing the information to identify the dysfunctional and functional brain tissues, and identifying the functional tissues having strong connections to the dysfunctional tissues.

8. The method of claim 7, wherein the strength of the connection may relate to the ability of the functional tissue to induce neuroplasticity in the dysfunctional tissue.

9. The method of claim 5, wherein the dysfunctional brain tissue relates to at least one of neurotransmitter-related function, motor or sensory-related function, memory, mental imagery, corpus callosum functions, defense responses, vagal or digestion functions, behavioural goals or any combination thereof.

10. The method of claim 5, wherein the mechanisms of neuroplasticity comprise promoting neurotransmitter release and levels, cell growth and dendritic branching, altered synaptic density or neurogenesis between the functional and dysfunctional tissues.

11. The method of claim 5, wherein the sensorimotor stimuli comprise one or more sensory stimuli, motor stimuli or a combination thereof.

12. The method of claim 5, wherein the sensorimotor stimuli are in the form of activities, exercises or sequences thereof.

13. The method of claim 5, further comprising measuring changes in the dysfunctional tissue and modifying the at least one sensorimotor stimuli in response to the changes.

14. The method of claim 13, wherein the method further serves to stabilize the changes in the dysfunctional tissue.

15. The method of claim 5, wherein the sensorimotor stimuli is performed at least once per day.

16. An apparatus for inducing neuroplasticity in dysfunctional brain tissue, the apparatus comprising:
at least one processor operative to:
obtain information indicative of one or more functional and dysfunctional brain tissues,
utilize the information to identify and select one or more functional brain tissues adjacent, neuroanatomnically-linked or otherwise associated with the dysfunctional brain tissues, and
identify and select one or more sensorimotor stimuli for inducing neuroplasticity in the functional brain tissue, promoting recovery in the dysfunctional brain tissue.

17. The apparatus of claim 16, wherein the apparatus further comprises internal or external data storing capabilities.

18. The apparatus of claim 16, wherein the apparatus is fully or partially automated.
